(19) United States
(12) Patent Application Publication
(10) Pub. No.: US 2011/0216696 A1
(43) Pub. Date: Sep. 8, 2011

(54) DISTRIBUTED FLUID NETWORK SYSTEM AND METHOD

(76) Inventors: Giorgio Lippolis, San Nicola la Strada (CE) (IT); Claudio Russo, Santa Maria a Vico (CE) (IT)

(21) Appl. No.: 12/719,611

(22) Filed: Mar. 8, 2010

(51) Int. Cl. H04W 40/00

(52) U.S. Cl. 370/328

(57) ABSTRACT

A system and method for transmitting message data within a multi-hop mesh network is disclosed. Message data is provided that includes an identifier of the source node, an identifier of the destination node, a transmission route and a message for the destination node. At least one processor tracks one or more of an incoming queue, an outgoing queue and an idle queue. The message data is transmitted from the source node to a destination node or, if the destination node is not directly connected, to an intermediate node, the receiving node determines whether it is the destination node and/or whether there is at least a first predetermined condition that precludes the message delivery. If no such condition is determined and the node is not the destination node, it continues forwarding the message to a subsequent and possibly the destination node, otherwise it attempts a re-routing and if it does not determine a second predetermined condition that precludes calculating a different route, drops the message and updates the knowledge base.

### BACKGROUND

1. Field

The teachings herein relate, generally, to communications and, more particularly, to a wireless mesh network provided with minimal configuration and maximal fail-safe protection.

2. Description of the Related Art

Prior art wireless networks, such as configured with a Wi-Fi router that broadcasts data over a particular range, are limited to nodes that are within a respective broadcast range. The transmission distance within a wireless network is quite small, often a matter of feet.

In response to limited transmission ranges of wireless networks, wireless mesh networks have been developed, which provide a decentralized system of connected nodes that transmit messages from a source node to a destination node using a plurality of wireless networks. Mesh networks are becoming useful in that relatively inexpensive hardware and software can be employed and maintained, and also offer an increased range of transmission. In a partial mesh network topology for example, nodes on the network are able to communicate (i.e., are connected) to one or more other nodes, but not to all of the other nodes on the network. For example, node A is connected to node B, but not to node C. Node B is connected to node A and to node C but not to node D. Node C is connected to node B and to node D, but not to node A. In a partial mesh network topology, node A can send a message to node D, via the intermediary nodes.

Thus, wireless mesh networks are known in which many-to-many connections are supported as nodes connect and disconnect to the network. Some of the nodes may include mobile units that change physical positions over time, such as personal digital assistants (“PDA's”), cellular or mobile telephones, or other mobile devices that transmit, for example, via Wi-Fi.

In a typical prior art mesh network, the transmission route is defined in its entirety by the first, source node. Prior art wireless mesh network architectures, or more specifically mobile ad-hoc networks (“MANETs”), typically adopt one or more of three classes of routing and updating algorithms: Pro-Active, Reactive and Flow-Oriented routing. Each of these algorithm classes tries to keep internal message routing tables up to date, using different approaches.

The proactive routing class employs pro-active routing protocols and maintains current lists of destinations and message transmission routes by periodically distributing routing tables throughout the network. The main disadvantages of this routing class include a large amount of data that is transmitted and referenced for maintenance, and relatively slow reaction times for restructuring and managing data communication failures.

The reactive routing class employs reactive routing protocols and finds a transmission route on demand by flooding the network with route request data transmission packets. As nodes receive the request packets, the route is generated. Disadvantages of reactive routing include a high latency time in discovering or generating a transmission route, and excessive data flooding that can lead to network congestion and that increases transmission times.

The third class, flow oriented routing, employs flow oriented protocols and finds a transmission route on demand by following current or existing flows of data. Disadvantages of flow oriented routing include a long amount of time required to explore new routes without prior knowledge of data flow rates, and may refer to entitative existing traffic to compensate for missing knowledge associated with routes.

Further, prior art Wi-Fi networks, typically, only support single-hop connections because communication is provided only to and from devices that are within a respective broadcast and reception range. Wi-Fi, per se, is not well-suited for prior art multi-hop transmissions.

Accordingly, it would be desirable to provide a wireless mesh network architecture that does not have or otherwise eliminates these and other prior art shortcomings, such as described above.

### SUMMARY

The present application provides, in one or more embodiments, a system and method for transmitting message data within a multi-hop mesh network from a source node to a destination node. The message data may include an identifier of the source node, an identifier of the destination node, a transmission route that represents at least a respective identifier any of a plurality of intermediate nodes between the source node and the destination node, and a message for the destination node. Further and in connection with this embodiment, at least one of the intermediate nodes is connected to at least one of the source node and the destination node via a bridged socket. In an alternative embodiment, the source node and the destination node are directly connected.

Further and continuing with these one or more embodiments, at least one processor tracks an incoming queue and an outgoing queue for at least one message from the source node to the destination node. The source node transmits the message data to one or more of the intermediate nodes over a communication network, and one or more intermediate nodes receive the message data. One or more of the intermediate nodes determine from the message data a next node for the message, and whether there is at least a first predetermined condition associated with the transmission route. Unless a predetermined condition occurs, one of the intermediate nodes forwards the message data to another of the intermediate nodes until the message data is received by the destination node.

In another embodiment, a wireless mesh network is provided that comprises at least one processor and at least one memory operatively connected to the processor. The at least one memory has a knowledge base stored thereon. The knowledge base includes information relating to a plurality of nodes, and includes information transmitted by any of the plurality nodes, and represents only network changes respectively discovered by one or more of a source node, a destination node and one or more discovered nodes.

Other features and advantages of the present application will become apparent from the following description that refers to the accompanying drawings, and from the claims of the application.

### BRIEF DESCRIPTION OF THE DRAWINGS

For the purpose of illustrating the application, there is shown in the drawings several forms which are presently preferred, it being understood, however, that the teachings herein are not limited to the precise arrangements and instrumentalities shown. The features and advantages of the present application will become apparent from the following description of the application that refers to the accompanying drawings, in which:

FIG. 1 shows an example hardware arrangement of a wireless mesh network in an embodiment;

FIG. 2 illustrates the functional elements of an information processor and/or node, in accordance with an embodiment;

FIG. 3 is a block diagram illustrating an example multi-hop wireless mesh network architecture in accordance with an embodiment;

FIG. 4 is a flowchart illustrating steps associated with managing a node via a mesh controller in accordance with an embodiment;

FIG. 5 is a flowchart illustrating steps associated with tracking incoming and outgoing queues, as well as an idle queue in accordance with an embodiment;

FIG. 6 is a flowchart illustrating steps associated with an example embodiment with a server thread in connection with mesh network traffic;

FIG. 7 is a flowchart illustrating steps associated with an example embodiment associated with handling an idle queue;

FIG. 8 is a flowchart illustrating steps associated with an example embodiment associated with handling an incoming queue;

FIG. 9 is a flowchart illustrating steps associated with an example embodiment associated with handling an outgoing queue;

FIG. 10 is a flowchart illustrating example steps associated with handling connections by mesh controller in accordance with an embodiment; and

FIGS. 11A and 11B are block diagrams illustrating sets of nodes and corresponding knowledge bases.

### DESCRIPTION OF EMBODIMENTS

In accordance with the present application, a system and method is provided to implement a multi-hop wireless mesh network architecture that is compatible with Wi-Fi transmissions and devices, and that offers a larger total capacity than typical prior art a single-hop Wi-Fi communications. The multi-hop wireless mesh network may be scalable in size and efficiency, and does not require exposed gateways or access points. Moreover, a multi-hop wireless mesh network architecture in accordance with the teachings herein supports on the fly reconfiguration and packet re-routing, as well as the ability to extend transmission ranges across ground networks and devices that are within transmission range of each other. In an example embodiment, the wireless mesh network employs a knowledge base that is built by merging and updating information that is discovered only via through neighbor nodes, recursively, thereby minimizing network traffic while simultaneously obtaining up-to-date information.

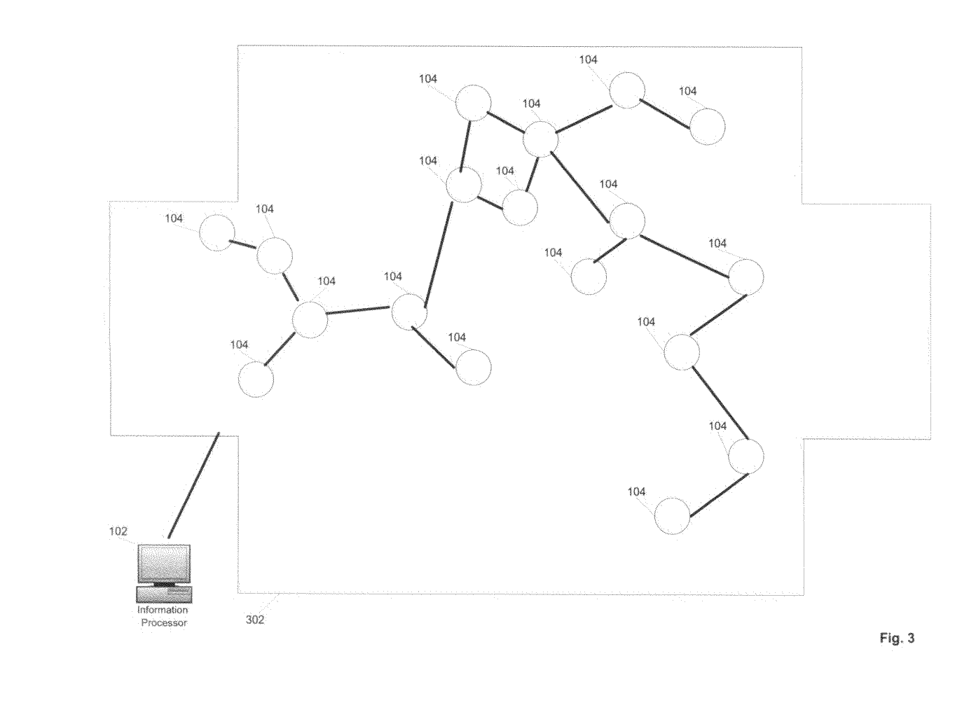

Accordingly, the present application relates to a network architectures design, and more particularly to fault tolerant wireless mesh networks. In an example embodiment, a software layer referred to herein generally as a mesh controller 302 (FIG. 3) is provided that monitors and/or tracks network nodes, their connectivity and the mesh network that is formed by the connected nodes. Once initialized, mesh controller 302 may track incoming, outgoing and idle connections that define a changing or “fluid” network, and mesh controller 302 may be operable and configured to update each node as required to keep information current and flowing across nodes of the network.

A fluid network in accordance with the present application may operate both on a message base and packet switched base. Both are handled transparently, as known in the art and, when required, re-routing involves a complete retransmission of the message starting from the current node in the route. In both cases the route is fully defined by the source node, and then data are sent to the nodes, each of which in turn forwards data as soon as the data arrive. Unlike prior art fluid networks, a message fragmentation algorithm is employed for a number of message pieces that are preferably sent across the network at the same time, and includes steps for message assembly at the destination node. The transmission preferably uses a bridged socket that is a particular structure opening up to two transmission channels used either in pass-through connection mode, as described below, or a buffered mode.

In the prior art, bridged sockets are not able to automatically configure mutable paths on networks that have ever changing topologies, nor to nodes 104 which have no stable Internet Protocol address (“IP address”) and port. Such mutable paths and dynamic networks are, however, well-supported in accordance with the teachings herein. A fluid network in accordance with the present application is able to re-route messages to one or more nodes, for example, provided that at least one path exists between all of the nodes in the route, although the same path need not be between all of the nodes. If there is a total break between independent networks, one or more nodes will not be visible, and data will not be transmitted.

The wireless mesh network architecture in accordance with the present application is designed to support both bridged connections and pass-through connections, as known in the art. A pass-through connection may be used to enable a node to forward incoming data to another node, without staging and buffering operations. Referred to herein, generally as a “data communication socket,” nodes that are configured according to the teachings herein are operable to function, via mesh controller 302, to receive and forward data messages. Moreover, the data messages according to the teachings herein may be packed with a mutable portion and an immutable portion. The mutable portion may include a packed list of suggested nodes for transmitting and/or routing, while the immutable portion contains data that is included in the message itself.

In accordance with the teachings herein, a “bridged connection” refers, generally, as a standard connection that is established between a sender node 104 and an intermediate node on route to the destination node, which may be located outside of communication range of sender node 104 and/or in a separated sub-network. This connection may be used to forward data to and from nodes that would otherwise be incapable of connecting with each other. Accordingly, routing and, when necessary or preferred, re-routing one or more data packets dynamically to reach the destination is fully supported via bridged connections.

In an embodiment, each node can modify the suggested node list to reflect topologic changes in the network structure, avoid congestion or suggest a faster path available through its bridged connections.

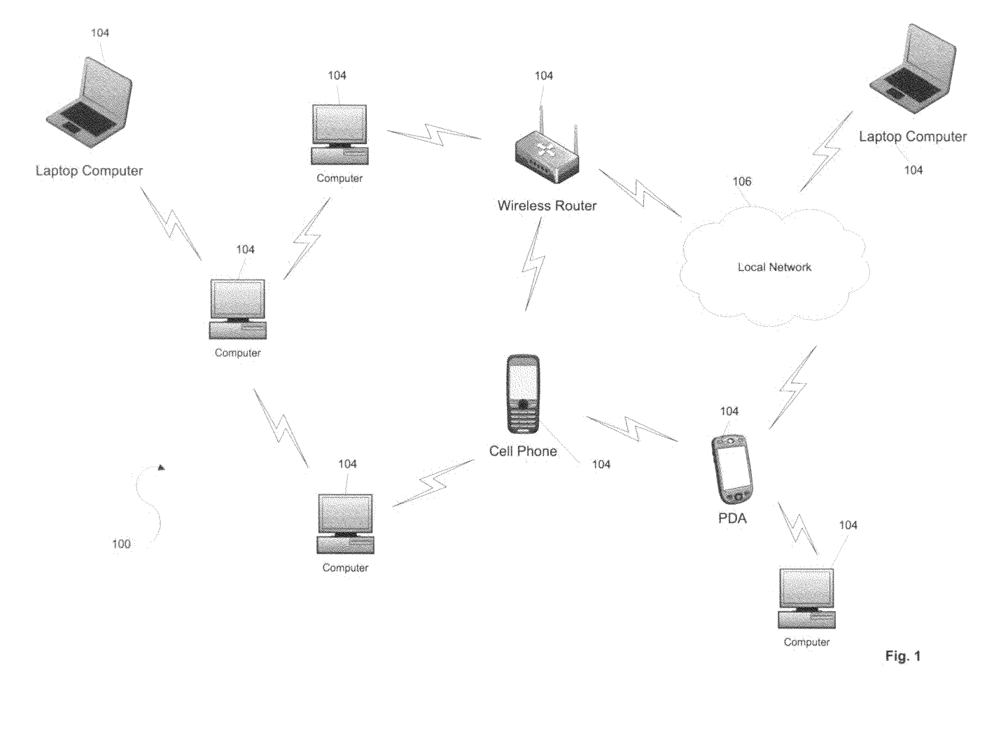

Referring now to the drawings, in which like reference numerals refer to like elements, FIG. 1 shows an example hardware arrangement in an example embodiment and referred to generally as system 100. The embodiment shown in FIG. 1 includes a plurality of hardware devices and corresponding network configurations that are operable in accordance with the teachings herein. Of course, one skilled in the art will recognize that many variations on the precise hardware configuration of the present application may be possible, and are envisioned herein without departing from the spirit of the present application.

In the embodiment shown in FIG. 1, system 100 comprises a plurality of devices that are configured to interact, in accordance with the teachings herein. Multiple Wi-Fi networks 106 may be provided, each may be operated by end users independently, without any carrier operator or infrastructure assistance. Nodes 104 are preferably configured automatically to send, receive and/or forward data transmissions and to cooperatively maintain the knowledge base up to date. Further, networks 106 may be configured as local area networks, Wi-Fi networks, or may be a global communication network, such as the Internet.

Nodes 104 may include any devices that are operable to communicate with any other device on the network. For example, nodes 104 may be configured as routers, personal computers, mobile telephones or other devices that are operable to transmit over a wireless network. During processing, a knowledge base data structure may be compiled into a cyclic graph, as known in the art. Nodes 104 may be visible to any other connected nodes 104 on network(s) 106. As referred to herein, “directly connected” nodes 104 are nodes 104 that are able to communicate with one or more devices that are inside the respective node's 104 limited range. Thus a node 104 is only “directly connected” to a limited number of distinct nodes 104, but may be still reachable by any other “bridged” node 104. In other words, a destination node 104 may be reachable through one or more nodes 104 located between the source node 104 and the destination node 104.

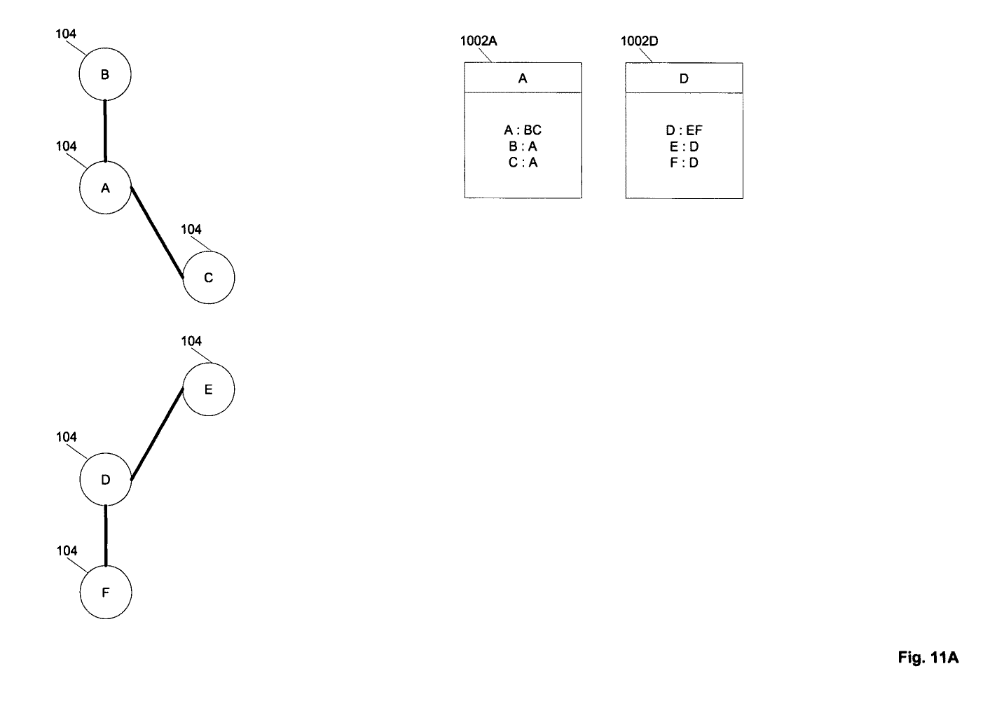

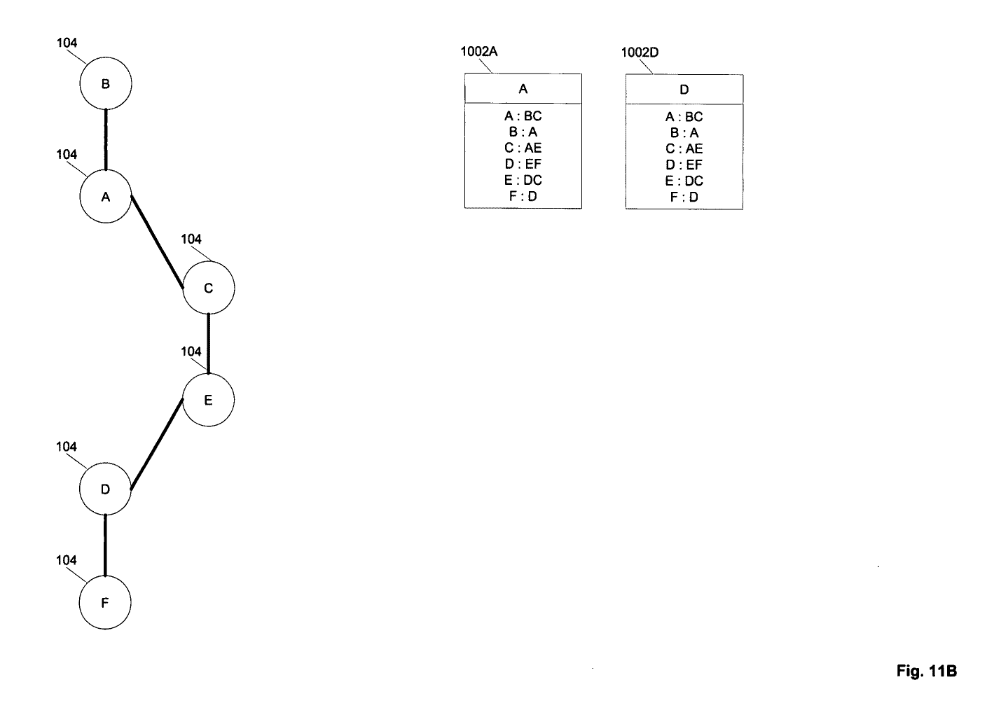

In an example embodiment, node 104 is a device capable to host a software layer, the knowledge base. The knowledge base may store information directed to nodes 104. Accordingly, the wireless mesh network system 100 in accordance with an example embodiment is a hybrid system that includes nodes 104 and, optionally, passive transmission devices like routers and/or access points. Nodes 104 normally perform neighborhood nodes discovery operations, message delivery and/or forwarding. Nodes 104 are programmed to access knowledge base 1002 (FIGS. 11A and 11B) for routing, traffic and statistical information, and a mesh controller to handle idle queues, incoming queues, outgoing queues, as well as to interface with nodes 104.

In an example embodiment, nodes 104 communicate via the known communication protocol, Transmission Control Protocol/Internet Protocol “TCP/IP”. In this way, content can be transmitted to and from nodes 104, and commands can be executed to enable the various functionality described herein.

As noted above, nodes 104 may be any devices that are capable of sending and receiving data across communication network 106, e.g., mainframe computers, mini computers, personal computers, laptop computers, personal digital assistants (PDA), cellular telephones, smart phones and tablet computers. Thus, as envisioned herein, nodes 104 are devices that can communicate over a network and can be operated anywhere, including, for example, moving vehicles.

The nature of the present application is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, MICROSOFT .NET, and a plurality of various web site development applications.

For example, data may be configured as a comma delimited ASCII text file, as a MICROSOFT SQL SERVER compatible table file (e.g., MS-ACCESS table), or the like. Moreover, one or more data formatting and/or normalization routines may be provided that manage data received from one or a plurality of sources. In another example, data are received that are provided in a particular format and programming routines are executed that convert the data to another format.

It is contemplated herein that any suitable operating system can be used on nodes 104, for example, DOS, Windows 3.x, Windows 95, Windows 98, Windows NT, Windows 2000, Windows ME, Windows CE, Windows PocketPC, Windows XP, Mac OS, Mac OSX, Unix, Linux, BSD, PalmOS or any other suitable operating system.

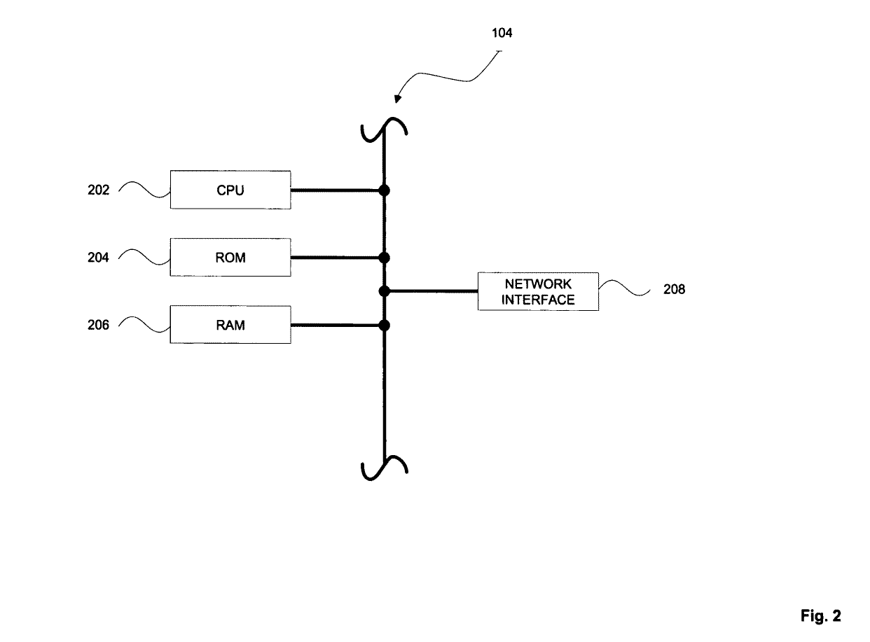

FIG. 2 illustrates functional elements of nodes 104, and include one or more central processing units (CPU) 202 used to execute software code and control the behavior of the node 104, read-only memory (ROM) 204, random access memory (RAM) 206, one or more network interfaces (208). Those skilled in the art will recognize that any other devices can be optionally added as required to operate in accordance with the specific field the implementor operates in, including but not limiting to input devices, displays, output devices (e.g., printers) and storage devices.

The various components of nodes 104 need not be physically contained within the same chassis or even located in a single location. For example, storage device 310 may be located at a site which is remote from nodes 104, and may even be connected to CPU 302 across communication network 106 via network interface 308. Nodes 104 may include a memory equipped with sufficient storage to provide the necessary databases, forums, and other community services as well as acting as a web server for communicating hypertext markup language (HTML), FLASH, Action Script, Java, Active Server Pages, Active-X control programs. Nodes 104 may be arranged with components, for example, those shown in FIG. 2, suitable for the expected operating environment. The CPU(s) 302, network interface(s) 308 and memory and storage devices are selected to ensure that capacities are arranged to accommodate expected demand.

Although the embodiments described above, particularly with reference with FIGS. 1 and 2, describe nodes 104 being configured with a processor and/or memory, the present application is not so limited. It is envisioned herein that a fluid network may be entirely a software layer, which may be installed and running on one or more of a plurality of devices and/or nodes 104. In this embodiment, each device is preferably self-contained on a network management basis, and there is no use of external or separate hardware computing devices that are configured in a pre-existing infrastructure.

Accordingly, the term “fluid network,” as set forth herein, relates to various contexts, and nodes 104 may take on particular meanings in connection therewith. For example, nodes 104 may be physical devices that are configured with a processor and/or memory. Alternatively, a node 104 may represent a message that is transmitted in connection with a respective queue, as discussed in greater detail, below. Moreover, a node 104 may relate to information regarding respective devices, such as in connection with a knowledge base and/or a “cyclic graph,” as discussed below. Moreover, nodes 104 may further represent symbolic names of a mutable addresses, and not necessarily physical devices. Thus, in an example embodiment, a single hardware device may comprise a working fluid network including a plurality of nodes 104.

According to an example embodiment of the present application, a fluid network exists in an autonomous way, which may not include the Internet. In one embodiment, the Internet extends fluid network and may be added at the application level. In any case, a fluid network preferably comprises at least 2 nodes 104. Additional nodes 104 that are discovered enable the fluid network to grow without requiring any functional modifications. In other words, additional or “intermediate” nodes 104 operate to transmit messages between a “sending” node 104 and a “destination” node 104, and each may perform the same steps. In this embodiment and unlike any intermediate nodes 104, however, the destination node 104 uses the message data, while the intermediate nodes 104 merely forward message data.

As used herein, the term “module” refers generally to one or more discrete components that contribute to the effectiveness of the present application. Modules can operate or, alternatively, depend upon one or more other modules in order to function.

In accordance with the present application, a wireless mesh network is provided that includes mesh controller 302 that is operable to track and manage incoming, outgoing and idle connections for nodes 104. Moreover, messages on the network may be dispatched from a source node 104 between nodes 104, via a plurality of queues (e.g., incoming queue and outgoing queue) to a destination node 104. In an example embodiment, a transmission route of the message is defined by the sender node, and a plurality of transmitting nodes 104 receive the message and forward the message to the next appropriate node 104 according to the defined transmission route, unless any of the transmitting nodes 104, pursuant to a predetermined condition, modifies the transmission route from the point of the transmitting node 104 forward. The predetermined condition may be, for example, an unavailable node in the transmission route, a transmission obstacle, network congestion, or a discovery of a new node that provides a better and/or more efficient transmission route. The mesh controller 302 of the fluid network according to an example embodiment is updated based upon information provided by neighboring nodes 104 within each node's 104 respective transmission range, thereby minimizing network traffic while simultaneously maintaining current information related to a dynamically changing network topography.

Thus, in an embodiment, the fluid network includes a plurality of nodes 104 that send and receive messages via mesh controller 302 that tracks incoming, outgoing and idle connections on the network 106. Nodes 104 operating on the fluid network, in accordance with the application, manage asymmetric connections for transmitting messages over the network. For example, node A transmits a message and tracks communications to B, but node B does not track communication from node A. This reduces a message's file size, as well as the computational requirements of a node, and the corresponding bandwidth needed the send the message.

In operation, each node on the network scans, within its respective transmission range, for neighboring nodes 104. As information relating to neighboring nodes 104 is discovered, the information is stored in a knowledge base 1002 (FIGS. 11A and 11B), which may be formatted as a table that is distributed among all nodes 104. In an example embodiment, knowledge base 1002 is formatted as a table-like data structure with sorted data for known connections between nodes 104. Moreover, knowledge base 1002 is used to evaluate routing paths and to store other information. For example and in addition to known connections, each row within a knowledge base 1002 table may include information such as metadata about a respective node 104, connection status or mapping information to accelerate routing and/or avoid traffic congestion, including known delays and preferred nodes 104. In order to conserve network traffic and bandwidth and in an example embodiment, only information representing network changes (e.g., newly discovered nodes 104 or nodes 104 that are not responsive) is transmitted by nodes 104 and used to update each the knowledge base on each receiving node 104. In this way and unlike prior art proactive routing systems, an entire knowledge base 1002 is not transmitted across the entire fluid network to countless nodes 104. Instead, only varying delta values are transmitted, which are compiled and modified within nodes 104.

Moreover, a node that sends a message over the network initially calculates the best possible route, and then sends the message along that route. Each node on the route forwards the message along the route without running further program instructions, unless a predetermined condition occurs. In that case, if an intermediate node 104 on the route identifies a better route, then that node replaces the data packet within the message with information representing the new route, and the message continues from that point forward along the new route and the next node in line forwards the message along the new route. Moreover, the fluid network according to the present application operates in a state of continual discovery of nodes 104 within each node's 104 respective transmission and reception range. The fluid network according to the present application is event-driven, whereby individual nodes 104 independently recalculate a message route only in response to one or more predetermined conditions, which precludes a need to cause each node along a message transmission route to calculate the complete route, thereby eliminating computational overhead that is added to each node.

Thus, each node in the fluid network accesses knowledge base 1002 with known connections between nodes 104, and the knowledge base is updated periodically with delta values received from neighboring nodes 104. Data messages are packed with a predefined route based on knowledge base 1002 from the message source node 104. Along the route, any intermediate node can modify the route to reflect topologic changes in the network structure, avoid congestion, or suggest a faster path available through its bridged connections. In an embodiment, a node that sends a message over the network initially calculates the best possible route, and then sends the message along that route. Each node on the route forwards the message along the route without running additional programmed instructions, unless a predetermined condition occurs.

Thus, each node in the fluid network accesses the knowledge base with known connections between nodes 104, and the knowledge base is updated periodically with delta values received from neighboring nodes 104. Data messages are packed with a predefined route based on the knowledge base from the message source node. Along the route, any intermediate node can modify the route to reflect topologic changes in the network structure, avoid congestion, or suggest a faster path available through its bridged connections.

FIG. 3 is a block diagram illustrating an example wireless mesh network in accordance with an example embodiment. As shown in FIG. 3, a plurality of nodes 104 are provided, of which some are directly connected to each other and some indirectly connected. Moreover, wireless mesh controller 302 is provided, which is configured as a ubiquitous software layer, and that may monitor and/or track network nodes 104, their connectivity and the network formed by being connected to each other. Once initialized, mesh controller 302 may track incoming, outgoing and idle connections that define fluid network.

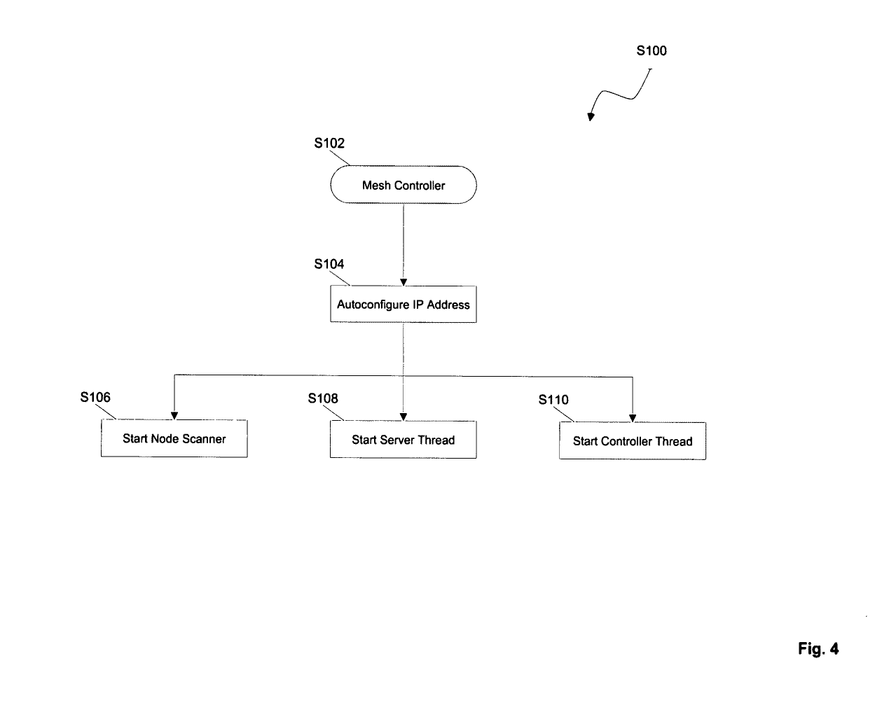

On startup, mesh controller 302 configures a node 104 that controller 302 is running on. Configuration preferably includes assigning a unique symbolic name that identifies node 104, and a locally unique network address, used to access the TCP/IP based communication network. The locally unique network address unique on the basis of the subnet mask and in case of conflict, a conflict resolution event is preferably generated and handled. When the mesh controller completes the address configuration, a single socket server thread is started to receive incoming requests. In addition to the server thread, a node scanner is started to start scanning for nearby nodes 104. FIG. 4 is a flowchart illustrating steps S100 associated with mesh controller 302 configuring a node 104 in accordance with the embodiment. As noted above, mesh controller 302 is configured and operable to monitor and keep track of nodes 104, as well as each node's 104 connection status and the network at large that is formed by connected nodes 104. As shown in FIG. 4, mesh controller 302 starts process S102 by auto-configuring a unique IP address for a respective node 104 (step S104). Once the respective node 104 is assigned an IP address, mesh controller 302 starts monitoring the connectivity of node 104 via node scanner (step S106). Further, mesh controller 302 starts a server thread to establish a single server socket (step S108) and a controller thread that starts processing events for the node 104 that mesh controller 302 is running on (step S110).

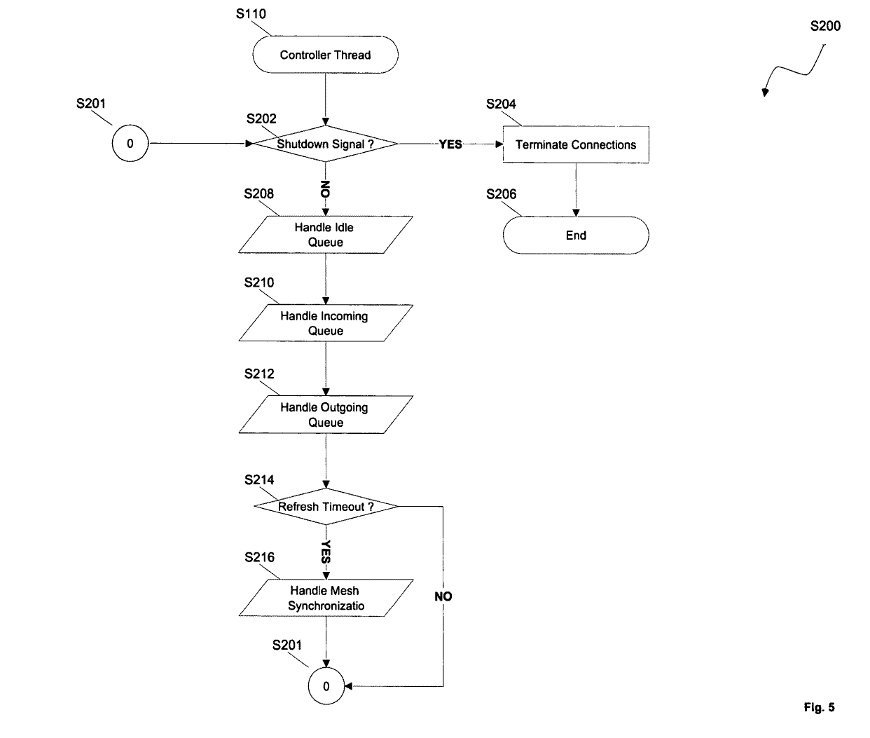

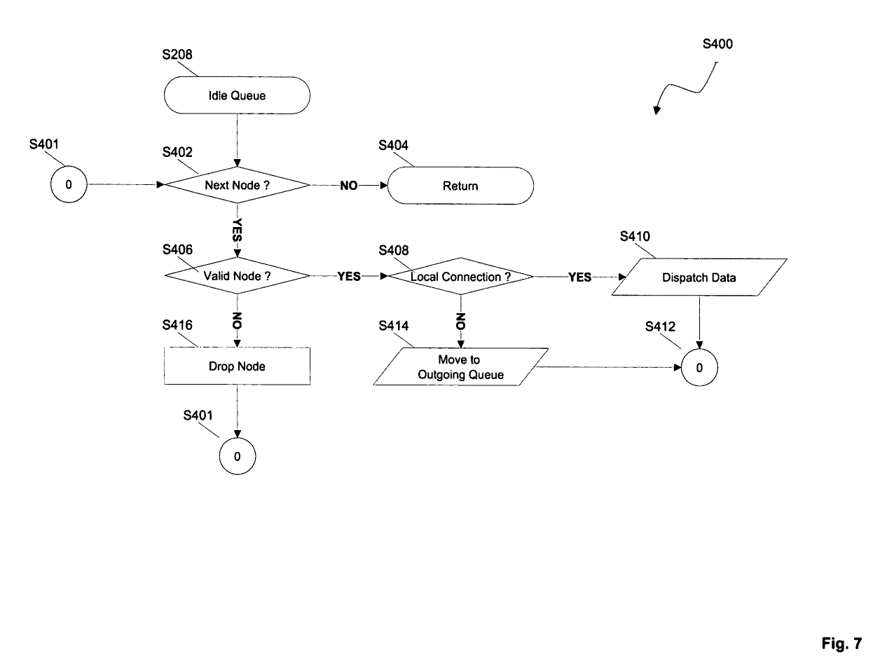

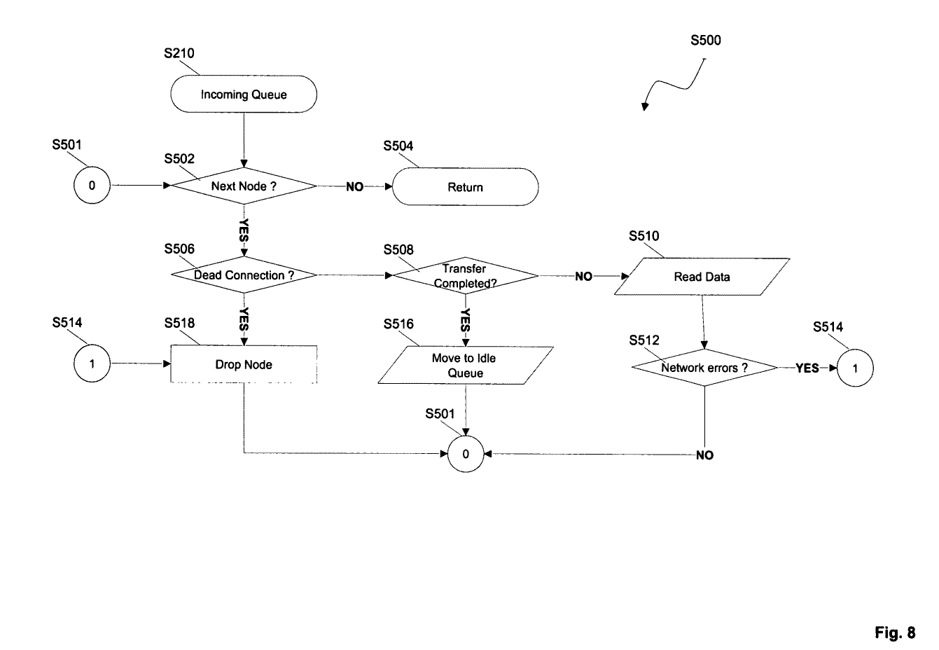

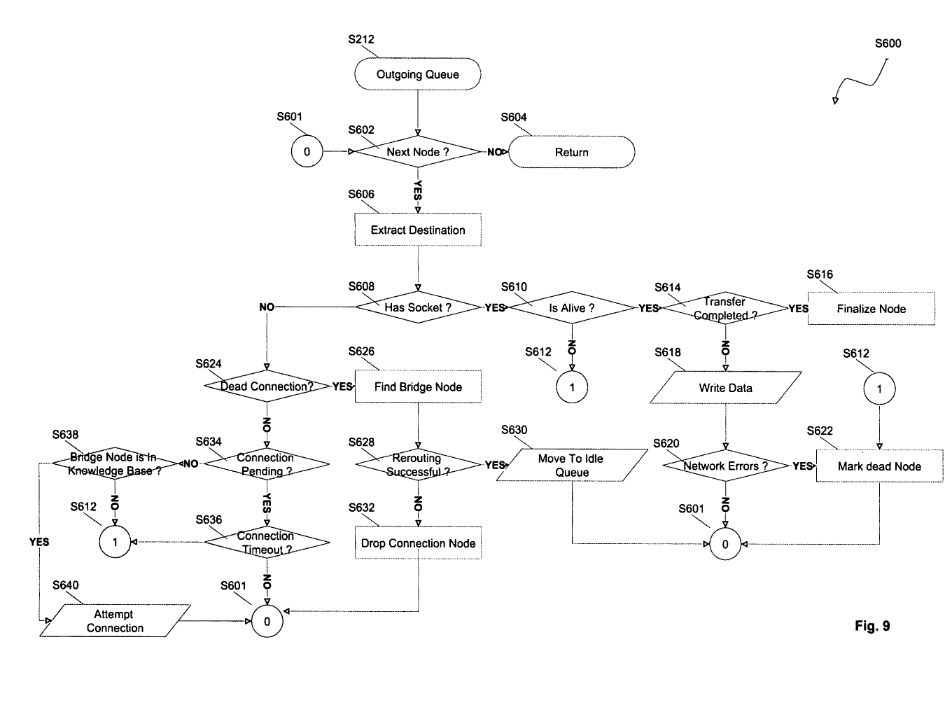

FIG. 5 is a flowchart showing steps S200 associated with mesh controller 302, including to track incoming and outgoing requests, as well as idle connections of one or more nodes 104. Each node 104 may be updated with information that enables messages to continue flowing through network 106. At step S110, a controller thread is started. At step 202, a determination is made whether a shutdown signal has occurred for one or more nodes 104. If so, then the process branches to step S204, and mesh controller 302 terminates the respective connection. From there, the process continues to step S206, and the process ends. Alternatively if no shutdown signal is received at step S202, the process branches and at least one of three steps occurs: an idle queue is handled (step S208), such as described in greater detail with reference to FIG. 7, an incoming queue is handled (step S210) such as described in greater detail with reference to FIG. 8, and/or an outgoing queue is handled (step S212) such as described in greater detail with reference to FIG. 9. Thereafter, the process continues to step S214 and a determination is made whether a refresh timeout occurs. As referred to herein, a refresh timeout relates to a maximum interval when the knowledge base will remain in a useful condition, while no events have been signaled or otherwise acknowledged. Once the refresh timeout is fired, mesh controller 302 validates the knowledge base 1002 by performing checks to remove obsolete data, isolated nodes and/or disconnected graphs as well as to update information kept inside a metadata zone, including but not restricted to load and traffic data, preferred routes and known delays. If the determination in step S214 is positive, then the process branches to step S216, and mesh controller 302 performs or otherwise handles a mesh synchronization process. As used herein, mesh synchronization relates to a procedure executed by mesh controller 302 on node 104 to rebuild area information from the last validated knowledge base information and the known data accessible through nearby nodes 104. Alternatively, if the determination in step S214 is not to refresh a timeout, then the process branches back to step S201.

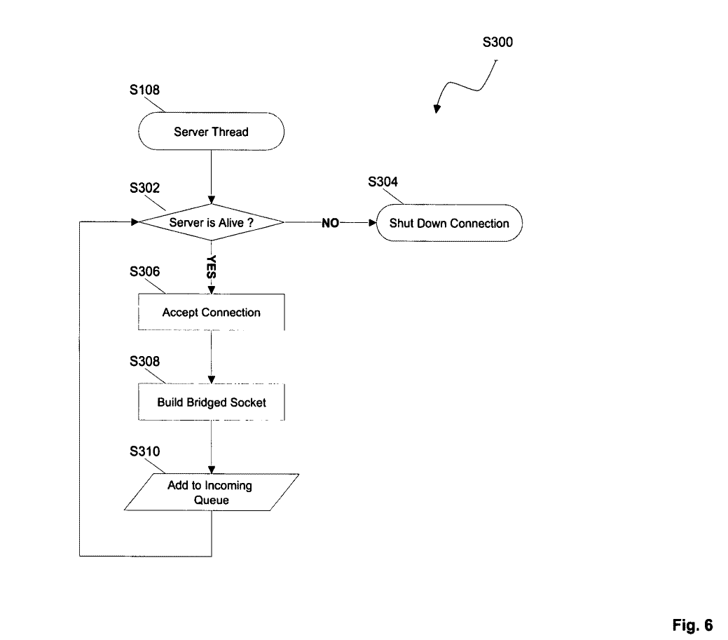

FIG. 6 is a flowchart illustrating steps S300 associated with an example embodiment for a server thread process that is performed in connection with mesh network traffic, such as to perform steps associated with network decongestion techniques. In an example embodiment, servers are dynamically connected and/or disconnected from the mesh network. When a network connection request from a server has been received and accepted, the connection may be converted to a bridged socket in the mesh network and entered into the incoming queue (FIG. 8). At step S108, the server thread runs and a determination is made whether the server is “alive”, for example, that the server is active and responsive on the network (step S302). If the determination in step S302 is that the server is not alive, then the process branches to step S304, and one or more instructions are executed to shut down the connection to the server. Alternatively, if the server is determined in step S304 to be alive, then the connection from the server is accepted (step S306). Thereafter, a bridged socket is built (step S308), and the mesh controller adds the newly connected server to an incoming queue (step S310), such as described in greater detail with reference to FIG. 8. Thereafter, the process branches back to step S302. The server thread in this embodiment is defined as a software module or program which is delegated to accept incoming connections. The server thread can perform filtering and refuse connections according to the current node 104 load status or address filtering events.

As described above, messages may be dispatched by mesh controller 302. Mesh controller 302 may send data to an appropriate subsystem or to a remote device across the network. Nodes 104 that send and receive messages that are not yet processed by mesh controller 302 may wait in an idle queue until mesh controller 302 processes them and prepares the nodes 104 for handling messages in an appropriate queue, such as an incoming queue or outgoing queue (FIGS. 8 and 9, respectively). In case an error occurs during a transmission of a message and that requires a re-transmission, one or more nodes 104 may be configured to operate or be “sent” back to an idle queue for an another message transmission attempt.

FIG. 7 is a flowchart illustrating steps S400 associated with an example embodiment associated with an idle queue. At step S208, an idle queue handling process occurs, and a determination is made whether a node of the queue (e.g., “next node”) requires handling (step S402). If the determination in step S402 is that there is not a node of the queue (e.g., the queue is empty), then the process returns (step S404) and the controller thread S110 of mesh controller 302 proceeds to handle the incoming queue (FIG. 5, step S210). In the alternative, if the determination in step S402 is that a queue node is to be handled, then the process branches to step S406 and a determination is made whether the queue node is valid. If the determination in step S406 is that the queue node is not valid, then the process branches to step S416 and the mesh controller drops the node 104 associated to the queue node from the idle queue. Thereafter, the process loops back to step S401. In the alternative and if the determination in step S406 is that the queue node is a valid node, then another determination is made whether the node 104 associated with the queue node has lost its connection to the network (step S408). If so, data regarding the lost connection is dispatched for updating the knowledge base 1002 (step S410). Thereafter, the process loops back to step S401. In the alternative, and the determination in step S408 is that there is no lost connection, then the queue node gets moved to an outgoing queue for further processing and transmission of the message (step S414). Thereafter, the process loops back to step S401.

In addition to handling idle connections in an idle queue, mesh controller 302 manages an incoming queue that may be configured as a lightweight data transfer engine. The incoming queue may handle data that are input from various bridged sockets, and performs basic coherency checks on the sockets. If an error occurs, mesh controller may, in an example embodiment, drop the connection(s). In that case, the node 104 currently sending or forwarding the message re-transmits the message either along the same route, or along a different route in order to deliver the message.

FIG. 8 is a flowchart illustrating steps S500 associated with an example embodiment associated with handling an incoming queue. At step S210, an incoming queue handling process occurs, and a determination is made whether a queue node (e.g., “next node”) is discovered that requires handling (step S502). If the determination in step S502 is that there is not a queue node to be handled in the incoming queue, then the process returns (step S504) and the controller thread S110 of mesh controller 302 proceeds to handle the outgoing queue (FIG. 5, step S210). In the alternative, if the determination in step S502 is that a queue node is to be handled, then the process branches to step S506 and a determination is made whether the connection to the associated node 104 is dead. If not, then the process branches to step S508 and a determination is made whether the message transfer is complete. If the message transfer is not complete, then the data in the message are read (step S510). Thereafter, the process continues and determination is made whether a network error has occurred (step S512). If so, then the process branches to step S514, and the queue node is dropped by mesh controller 302 (step S518). Alternatively and the determination in step S512 is that there is no network error, then the process branches back to step S501. If, based on the determination performed in step S508, the transfer is complete, the process ends and branches back to step S501. Moreover and if, based on the determination in step S506, the connection to the associated node 104 is dead, the queue node along with the associated node 104 is dropped by mesh controller 302 (step S518), and the process loops back to step S501.

In an example embodiment, an outgoing queue is managed by mesh controller 302 and uses asynchronous connections. Asynchronous connections may be made for coping with potentially limited processing power of nodes 104. Accordingly, new node 104 connections may be established in an out of order fashion, with respect to the control flow. The outgoing queue is a complex subsystem and is programmed and configured to handle both data transmission, error/failure handling, and real time mesh reconfiguration.

FIG. 9 is a flowchart illustrating steps S600 associated with an example embodiment associated with handling an outgoing queue. At step S212, an outgoing queue handling process occurs, and a determination is made whether a queue node (e.g., “next node”) is discovered that requires handling (step S602). If the determination in step S602 is that there is not a queue node to be handled in the outgoing queue, then the process returns (step S604) and the controller thread S110 of the mesh controller 302 proceeds to step S214 (FIG. 5). In the alternative, if the determination in step S602 is that a queue node is to be handled, then the process branches to step S606, and information representing the destination node 104 is extracted from the message. Thereafter, a determination is made whether the queue node in the outgoing queue to transmit a message has been assigned a valid bridged socket for receiving the message (step S608). If so, then the process branches to step S610 and a determination is made whether the associated node 104 is functioning and/or responsive (i.e., is “alive”). If not, then the process branches to step S612, and the process continues to step S622, and mesh controller 302 marks the associated node 104 as dead, the process loops back to step S601. If in the alternative the determination in step S610 is that the associated node 104 is alive, then another determination is made whether the message transfer is complete (step S614). For example, the determination in step S614 is whether the message has now reached its destination node 104. If so, then the process branches to step S616 and mesh controller 302 completes the transfer process (“finalizes the queue node”). Alternatively and if the transfer is not complete, then the process branches to step S618, and data in the message is written. According to this embodiment, a data transfer operation is both asynchronous and non-atomic, and thus is not guaranteed that the message data is transferred into a single cycle. Also and according to this current embodiment, data transfer is referred to message data prefixed with routing information. Thereafter, the process branches to step S620 and a determination is made whether a network error occurred. If so, then the process branches to step S622 and mesh controller 302 marks the associated node 104 as dead, the process loops back to step S601. If no network error is discovered in step S620, then the process loops back to S601.

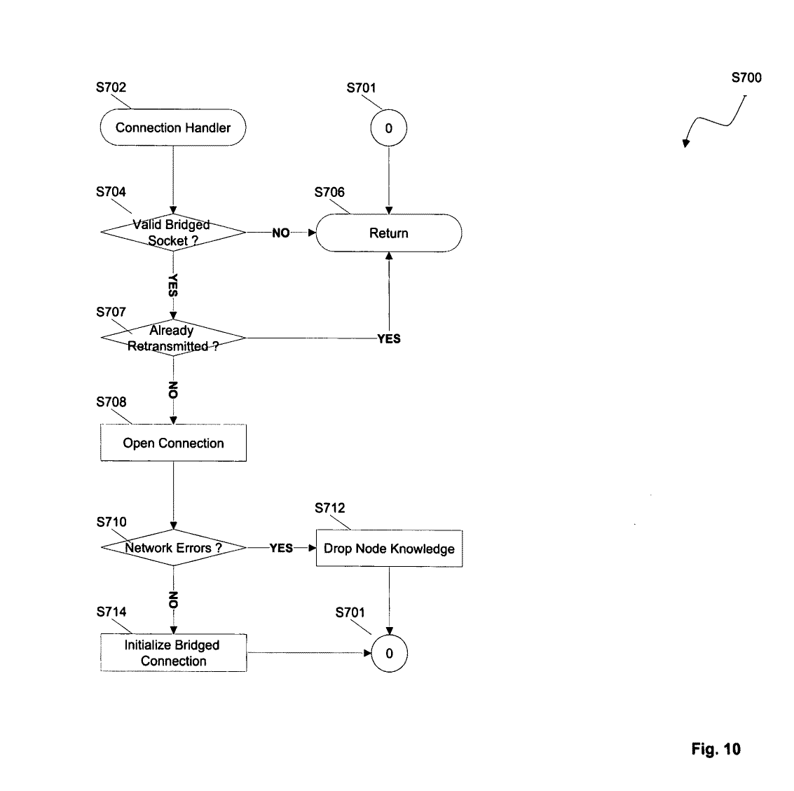

Continuing with reference to FIG. 9, in case the determination at step S608 is that the next node in the queue has not been assigned a valid socket, then the process branches to step S624 and a determination is made whether there is no connection to the associated node 104 (i.e., the connection is dead). If the connection is dead, then an alternative bridged node is located for forwarding the message (step S626). Thereafter, a determination is made whether re-routing to the alternative bridged node is successful (step S628). If so, then the node is moved to the idle queue (steps S400) (step S630). Alternatively, if the re-routing is not successful, then mesh controller 302 drops connection node to the alternative bridged node, and the process loops back to step S601. In the alternative, if the determination at step S624 is that the connection is not dead, then the process branches to step S634 and a determination is made whether a connection is pending for the bridged socket. If not, then another determination is made whether the bridged node is in knowledge base 1002 (step S638). If the bridged node is not in knowledge base 1002, then the process branches to step S612, and mesh controller 302 marks the node 104 as dead (step S622) and the process loops back to step S601. Alternatively, if the determination in step S638 is that the bridged node is in knowledge base 1002, then the process branches to step S640, and a connection attempt is made with the bridged node, such as described with reference to FIG. 10. Thereafter, the process loops back to step S601. A bridged node in this context is referred to a node 104 used to bring a message from a source node 104 to a destination node 104 not directly connected.

FIG. 10 is a flowchart illustrating example steps S700 associated with handling connections by mesh controller 302. At step S702, a connection handler is invoked from step S640 of the outgoing queue (FIG. 9), and a determination is thereafter made whether a queue node has a valid bridged socket assigned (step S704). If the determination in step S704 is that the there is no valid bridge socket, then the process branches to step S706, and the process returns. Alternatively, if the bridge socket is valid then another determination is made whether the message has already been re-transmitted (step S707). If so, then the process branches to step S707, and the process returns. Alternatively, if the determination in step S707 is that the message has not been re-transmitted, then the process branches to step S708 and a data connection is opened. Thereafter, the process continues and determination is made whether a network error has occurred (step S710). If so, then the process branches to step S712, and the node is dropped by mesh controller 302, including all knowledge of the node from the knowledge base (step S712). Alternatively and the determination in step S710 is that there is no network error, then the process branches to step S714, and the bridged connection is initialized. Thereafter, the process loops back to step S701.

FIGS. 11A and 11B are block diagrams illustrating sets of nodes 104 and corresponding knowledge bases and that represent two independent systems that, when connected, represent a fluid network. As noted above, the knowledge base may be formatted in a table-like data structure that sorts known connections between nodes. The knowledge base 1002 may be used to evaluate routing paths. As illustrated in FIGS. 11A and B, each node 104 keeps a respective copy of the knowledge base and periodically probes for nodes 104 that are within a respective transmission and/or connection range for updates. In the example shown in FIGS. 11A and 11B, knowledge base 1002A is for the node 104A, and knowledge base 1002B is for node 104B. In order to improve transmission efficiency of prior art mesh networks, the request can either be marked with an individual timestamp or individually mark the requested rows.

In FIG. 11A, two separate systems are shown, nodes 104A, 104B and 104C, and 104D, 104E and 104F. The two systems cannot communicate because there is no bridged connection between them. In FIG. 11B, node 104A receives an update from node 104C which discovers node 104E, and node 104A merges the new info into its knowledge base 1002A, and updates the timestamp of the changed rows. This time stamp is usable to filter update requests from nearby nodes to avoid updating or sending obsolete information. After a variable set-up time, each node 104A-104F will have its own synchronized copy of knowledge base 1002. Any node 104 connecting two separate systems realizes a bridge and a connection through a bridge that is defined a bridged socket connection, as illustrated in FIG. 11B.

The following example describes a scenario wherein four nodes 104A, 104B, 104C and 104D start a fluid network “stack,” as known in the art, and each of the four nodes 104 is initially provided with an empty knowledge base 1002. Initially, the first connection that each network node 104A-104D discovers is its own. For example, node 104A discovers itself, and node 104B discovers itself. Thereafter, two pairs of nodes are discovered, nodes 104A and 104B and nodes 104C and 104D, which are visible in pairs. At this point during the discovery phase node 104A detects node 104B, node 104B detects node 104A, node 104C detects node 104D and node 104D detects node 104C. This discovery may occur, for example, either using RAW socket connections or ARP pinging, as known in the art.

When many nodes 104 are operable on a fluid network in accordance with the teachings herein, discoveries may trigger events to register delta conditions, referred to herein as a “DELTA ADD” event. This involves the creation of a packed list of newly discovered nodes, along with the source node (used to build the cyclic graph, as described above). In the present example, however, there are no other nodes that are discovered at this stage, so no “DELTA ADD” is sent.

Continuing with the present example, eventually node 104C connects with node 104A, and the two nodes discover each other. At this time, since node 104A also knows node 104B and node 104C also knows node 104D, node 104A transmits a message encoding a sequence, such as “DELTA ADD 104C FROM 104A and TIMESTAMP.” This message is transmitted to node 104B. Similarly, node 104C sends message, such as “DELTA ADD 104A FROM 104C and TIMESTAMP,” which is sent to node 104D. When node 104A receives its message, node 104A processes the information and, forwards the message to node 104B. Similarly when node 104C receives the message from node 104A, node 104C processes the information and forwards the message to node 104D. When that occurs, the nodes 104 have a knowledge base that is current, and by using the time stamping information, the nodes 104 can evaluate which nodes 104 are likely to require updated information about the newly discovered pair. As connections change, the knowledge base is updated and used to maintain current connectivity and availability. For example node 104A may determine that node 104C lacks information about node 104B, and node 104C may determine that node 104A was disconnected from node 104D. Accordingly, the nodes 104 may exchange another DELTA message, with an appropriate list of nodes and timestamps. Any message receiving node 104 evaluates the timestamp information on a per node basis to determine whether new information has been provided, or whether the receiving node 104 should make some use of the newly received information received. In this way, only useful information is propagated and the knowledge base transmissions are extremely efficient.

Moreover and for nodes 104 that become disconnected, there may be only a “DELTA DEL 104X FROM 104Y and TIMESTAMP” message sent to each neighboring node 104, thereby propagating only information that is necessary to keep the knowledge base 1002 synchronized and current. In one embodiment, a “DELTA DEL” message can be generated upon discovery of a connection failure, for example originating from a lack of feedback from network scan, or a stack reset, as known in the art. Moreover, and as described above with reference to FIGS. 4-10, mesh controller 302 may drop nodes upon handling of one or more respective queues.

Thus, as shown and described herein, an improved multi-hop wireless mesh network architecture is provided that is compatible with a plurality of Wi-Fi networks, and that offers a much larger total capacity than a prior art single-hop Wi-Fi cell. Further, the teachings herein provide for a low maintenance, and highly efficient scalable architecture that supports on the fly reconfiguration and packet re-routing as well as a possibility to extend transmission range across ground networks and/or directly connected devices.

The fluid network according to the present application may operate in a state of continual discovery of nodes 104 within each node's 104 respective transmission and reception range. The fluid network according to the present application may be event-driven, whereby individual nodes 104 independently recalculate a message route only in response to one or more predetermined conditions, and that precludes a need to cause each node along a message transmission route to calculate the complete route, thereby eliminating computational overhead that is added to each node.

The present application describes a technology that, in an example embodiment, is usable to transmit short text messages among devices. In this embodiment, messages are transferred between nodes 104 that belong to networks 106 may be disjoined from each other, and each node 104 scans its respective knowledge base 1002 for connection points that enable the nodes 104 to generate or determine a path from a sender node 104 to a receiver node 104. Continuing with this example embodiment, upon message reception the destination node 104 may perform various operations. For example, node 104 may display the message, may store the message on some non-transitory processor readable media, may cause the message to be output, such as to a printing device (e.g., a line printer), or may forward the message to another node 104 that is operatively coupled connected to a printing device to produce a hard copy of the message. Moreover, the destination node 104 may be provided with a display or an audio output device, and may provide a multimedia output, such as audio and/or moving video output, as well. Accordingly, one skilled in the art will recognize that the teachings herein apply to a multitude of different data types, from documentation and multimedia streams to control signal monitoring.

Although the present application has been described in relation to particular embodiments thereof, many other variations and modifications and other uses will become apparent to those skilled in the art. It is preferred, therefore, that the present application be limited not by the specific disclosure herein.

What is claimed is:

1. A method for transmitting message data within a multi-hop mesh network from a source node to a destination node, the method comprising:
a) providing the message data, wherein the message data includes an identifier of the source node, an identifier of the destination node, a transmission route that represents at least a respective identifier any of a plurality of intermediate nodes between the source node and the destination node, and a message for the destination node, wherein either at least one of the intermediate nodes is connected to at least one of the source node and the destination node via a bridged socket, or the source node and the destination node are directly connected;
b) tracking, by at least one processor, an incoming queue and an outgoing queue, for at least one message from the source node to the destination node;
c) transmitting over a communication network, from the source node to one or more of the intermediate nodes, the message data;
d) receiving, by one or more intermediate nodes, the message data;
e) determining, by one or more of the intermediate nodes from the message data, a next node of the plurality of intermediate nodes, and whether there is at least a first predetermined condition associated with the transmission route;
f) forwarding, by one of the intermediate nodes, the message data to another of the intermediate nodes, unless one or more predetermined conditions occur; and
g) repeating steps f), d) and e) until there are no intermediate nodes;
h) forwarding, by one of the intermediate nodes, to the destination node, the message data and
i) receiving, by the destination node, the message data.

2. The method of claim 1, wherein at least one of the predetermined conditions is a topologic change in the communication network or network congestion.

3. The method of claim 1, wherein at least one of the predetermined conditions is based on a knowledge base.

4. The method of claim 3, wherein the knowledge base is updated by information transmitted by at least one of the source node, the destination node and one or more of the intermediate nodes.

5. The method of claim 4, wherein the information transmitted by at least one of the at least one of the source node, the destination node and one or more of the intermediate nodes represents one or more of a newly discovered node and an unresponsive node.

6. The method of claim 4, wherein the information transmitted by at least one of the source node, the destination node and one of or more of the intermediate nodes represents only network changes respectively discovered by one or more of the source node, the destination node and one or more intermediate nodes.

7. The method of claim 1, wherein the tracking is performed by a mesh controller.

8. The method of claim 7, wherein the mesh controller includes at least one instruction that is executed by at least one of the source node, the destination node and one or more of the intermediate nodes.

9. The method of claim 1, further comprising:
modifying, by one or more of the intermediary nodes, the transmission route if the one or more of the intermediate nodes determines the at least first predetermined condition, wherein the modified transmission route includes an identifier of another of the intermediate and excludes the identifier of the next of the intermediate nodes;
modifying the message data, by one or more of the intermediary nodes, with the modified transmission route; and
transmitting, by the one or more of the intermediary nodes, the modified message data to a subsequent intermediate node.

10. The method of claim 1, further comprising outputting the message data to at least one of a printer and a display.

11. A system for transmitting message data within a multi-hop mesh network from a source node to a destination node, the system comprising:
a source node that includes a source node processor and a source node memory operatively coupled to the first processor to form a source node communication device;
a destination node that includes a second processor, a second memory operatively coupled to the second processor to form a second communication device;
one or more intermediate nodes, each comprising a respective intermediate node processor and a respective intermediate node memory to form one or more intermediate node communication devices;
message data provided by the source node, wherein the message data includes an identifier of the source node, an identifier of the destination node, a transmission route that represents at least a respective identifier of any of the one or more intermediate nodes between the source node and the destination node, and a message for the destination node,
at least one bridged socket through which the source node is connected to at least a second node;
at least bridged socket through which at least one destination node is connected to at least a second node;
a mesh controller running on the source node, the destination node and any of the one or more intermediate nodes, wherein the mesh controller tracks at least one incoming queue and an outgoing queue;
a first instruction, when executed by the source node processor, causes the source node to transmit the message data to the first of the intermediate nodes over a communication network;
a second instruction, when executed by a processor of any node, causes the any node to determine from the message data the destination node, the transmission route, and whether there is at least a predetermined condition associated with the message data;
a third instruction, when executed by the processor of the any node, causes the any node to forward the message data to a subsequent one of the one or more intermediate nodes unless the any node determines the predetermined condition; and
a fourth instruction, when executed by the processor of the any node, causes the any node to determine from the message data to be the destination node, and whether there is at least the predetermined condition or a different predetermined condition associated with the message data,
wherein the destination node receives the message data if any of the one or more intermediate nodes does not determine the predetermined condition or the different predetermined condition.

12. The system of claim 11, wherein the predetermined condition or the different predetermined condition is one or more of a topologic change in the communication network, a software stack and network congestion.

13. The system of claim 11, further comprising a knowledge base, wherein the predetermined condition, the different predetermined condition is determined as a function of the knowledge base, and further wherein the knowledge base is stored on the source node, the destination node and any of the one or more intermediate nodes.

14. The system of claim 13, wherein the knowledge base is updated by information transmitted by at least one of the source node, the destination node and any of the one or more intermediate nodes.

15. The system of claim 13, wherein the knowledge base contains information that is not a perfect replica among at least one of the source node, the destination node and any of the one or more of the intermediate nodes.

16. The system of claim 14, wherein the information transmitted by at least one of the at least one of the source node, the destination node and any of the one or more intermediate nodes represents one or more of a newly discovered node and an unresponsive node.

17. The system of claim 14, wherein the information transmitted by the at least one of the source node, the destination node and one or more of the intermediate nodes represents only network changes respectively discovered by one or more of the source node, the destination node and one or more of the intermediate nodes.

18. The system of claim 11, wherein the mesh controller includes at least one instruction.

19. The system of claim 11, further comprising:
a fifth instruction, when executed by the processor, causes the intermediary node to modify the transmission route if the node itself determines the at least first predetermined condition, wherein the modified transmission route includes an identifier of a different intermediate node and excludes the identifier of the present intermediate node;
a sixth instruction, when executed by any respective intermediary processor, causes the respective intermediary node to modify the message data with the modified transmission route; and
a seventh instruction, when executed by the respective intermediary processor, causes the respective intermediary node to transmit the modified message data to the subsequent one of the one or more intermediate nodes.

20. The system of claim 11, further comprising at least one of a printer and a display, wherein the destination node causes the message data to be outputted to one or more of the at least one of a printer and display.

21. A wireless mesh network, the wireless mesh network comprising:
at least one processor;
at least one memory operatively connected to the at least one processor, wherein the at least one memory has stored:
a knowledge base including information relating to a plurality of nodes, wherein the knowledge base includes information transmitted by any of the plurality nodes and that represents only network changes respectively discovered by one or more of a source node, a destination node and one or more discovered nodes.
